(19) United States
(12) Patent Application Publication
(10) Pub. No.: US 2021/0314376 A1
(43) Pub. Date: Oct. 7, 2021

(54) INFORMATION TERMINAL, CONTROL APPARATUS, EXTERNAL APPARATUS, AUTHENTICATION PROCESSING SYSTEM, AND AUTHENTICATION METHOD

(71) Applicant: SHARP KABUSHIKI KAISHA, Osaka (JP)

(72) Inventor: AKIRA DOIDA, Tokyo (JP)

(21) Appl. No.: 17/187,555

(22) Filed: Feb. 26, 2021

(30) Foreign Application Priority Data
Apr. 6, 2020 (JP) 2020-068184

(51) Int. Cl. H04L 29/06; H04N 21/258

(52) U.S. Cl. CPC H04L 65/4084; H04N 21/25875; H04N 21/25816

(57) ABSTRACT

An information terminal includes at least one control apparatus, at least one imaging unit, at least one communication unit, and at least one operation unit. The control apparatus is configured to perform a process of acquiring identification information of an external apparatus by analyzing an image including the identification information of the external apparatus wherein the image is obtained by the imaging unit by imaging the identification information displayed on the external apparatus, a process of, via the communication unit, transmitting information, which is to be used in an authentication process and which is input via the operation unit, to an authentication server and receiving key information from the authentication server, and a process of transmitting the key information by using the identification information to the external apparatus via the communication unit.

### CROSS-REFERENCE TO RELATED APPLICATION

The present application claims priority from Japanese Application JP2020-G68184, the content of which is hereby incorporated by reference into this application.

### BACKGROUND

### 1. Field

The present disclosure relates to an information terminal, a control apparatus, an external apparatus, an authentication processing system, and an authentication method, used in an authentication process.

### 2. Description of the Related Art

A TV broadcasting receiving apparatus has been developed which has a capability of connecting to the Internet to allow it to view a content on a network. A technique related to this TV broadcasting receiving apparatus is disclosed in Japanese Unexamined Patent Application Publication No. 2009-169547 (laid open on Jul. 30, 2009).

That is, Japanese Unexamined Patent Application Publication No. 2009-169547 discloses a technique for facilitating authentication for playing a content or the like. Each time a content transmission request is received, a server subsystem generates an AV code signal corresponding to a password for authentication and transmits it, in a two-dimensional barcode format, to an AV apparatus. A portable terminal captures an image of the two-dimensional barcode displayed on a TV display of the AV apparatus, analyzes it, and transmits an AV code obtained as a result of the analysis to the server subsystem. The server subsystem performs the authentication process using the AV code received from the portable terminal.

However, in the technique disclosed in Japanese Unexamined Patent Application Publication No. 2009-169547, each time a content transmission request is received, the server subsystem generates an AV code signal and transmits it in the two-dimensional barcode format and performs the authentication process using the AV code received from the portable terminal. As a result, the authentication process is performed a large number of times, which results in a long processing time. In addition, since an AV code signal is generated and managed in response to each content transmission request, the management of the AV code is complicated.

According to an aspect, the present disclosure provides an information terminal capable of performing an authentication process in an easy manner.

### SUMMARY

According to an aspect, the present disclosure provides an information terminal including at least one control apparatus; at least one control apparatus, at least one imaging unit, at least one communication unit, and at least one operation unit, the control apparatus being configured to perform a process of acquiring identification information of an external apparatus by analyzing an image including the identification information of the external apparatus wherein the image is obtained by the imaging unit by imaging the identification information displayed on the external apparatus, a process of, via the communication unit, transmitting information, which is to be used in an authentication process and which is input via the operation unit, to an authentication server and receiving key information from the authentication server, and a process of transmitting the key information by using the identification information to the external apparatus via the communication unit.

According to an aspect, the present disclosure provides a control apparatus configured to control an information terminal, the information terminal including at least one imaging unit, at least one communication unit, and at least one operation unit, the control apparatus including an image analysis unit configured to acquire identification information of an external apparatus by analyzing an image including the identification information of the external apparatus wherein the image is obtained by imaging, by the imaging unit, the identification information displayed on the external apparatus, and a communication control unit configured to perform, via the communication unit, transmitting information, which is to be used in an authentication process and which is input via the operation unit, to an authentication server, receiving key information from the authentication server, and transmitting the key information by using the identification information to the external apparatus.

According to an aspect, the present disclosure provides an external apparatus including at least one control apparatus, at least one communication unit, and at least one display unit, the control apparatus being configured to perform a process of performing control such that an image including identification information of the external apparatus is displayed on the display unit, a process of receiving, via the communication unit, key information transmitted from an information terminal by using the identification information, and a process of transmitting, via the communication unit, a content viewing request using the key information.

According to an aspect, the present disclosure provides an authentication processing system including an information terminal, and an external apparatus, the external apparatus being configured to display an image including identification information of the external apparatus, the information terminal being configured to perform imaging the image displayed on the external apparatus, acquiring identification information of the external apparatus by analyzing the image obtained by the imaging, transmitting information input by a user to be used in an authentication process to an authentication server, and transmitting, using the identification information, key information received from the authentication server to the external apparatus, and the external apparatus being configured to transmit a content viewing request using the key information received from the information terminal.

According to an aspect, the present disclosure provides an authentication method in an authentication processing system, authentication processing system including an information terminal and an external apparatus, the authentication method including, by the external apparatus, displaying an image including identification information of the external apparatus, by the information terminal, capturing the image displayed on the external apparatus, analyzing the captured image, and acquiring the identification information of the external apparatus, by the information terminal, transmitting information, which is to be used in an authentication process and which is input by a user, to an authentication server and receiving key information from the authentication server, by the information terminal, transmitting the key information using the identification information to the external apparatus, and by the external apparatus, transmitting a content viewing request, using the key information received from the information terminal, to a content providing site.

### BRIEF DESCRIPTION OF THE DRAWINGS

FIG. 1 is a block diagram illustrating a functional configuration of an information terminal and an external apparatus according to the present disclosure;

FIG. 2 is a diagram illustrating an example of a hardware configuration of an information terminal;

FIG. 3 is a sequence diagram illustrating a processing procedure performed by an authentication processing system including an information terminal and an external apparatus; and

FIG. 4 is a sequence diagram for illustrating a processing procedure performed by an authentication processing system according to a related technique.

### DESCRIPTION OF THE EMBODIMENTS

### Related Technique

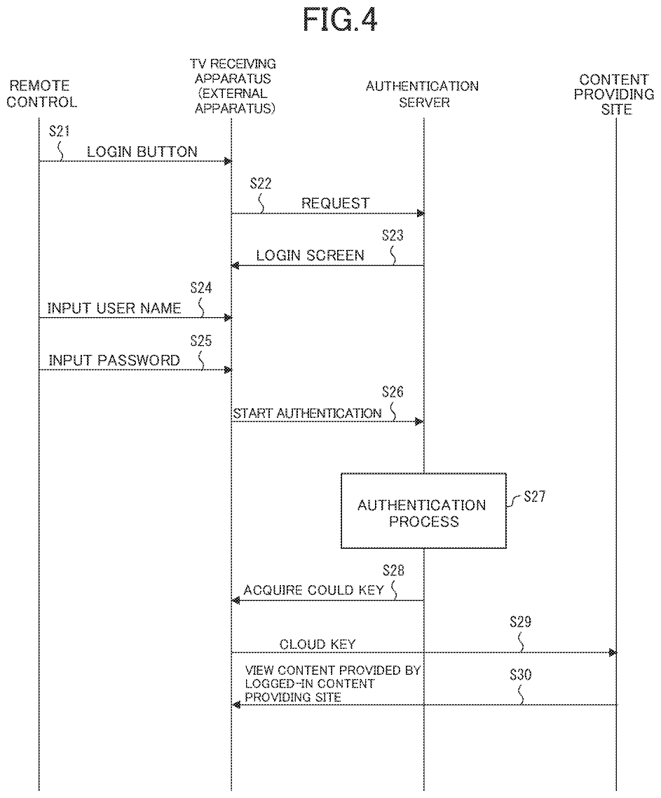

First, before describing an information terminal and an authentication processing system using an information terminal in accordance with an embodiment of the present disclosure, related techniques are described. FIG. 4 is a sequence diagram for illustrating a processing procedure performed by an authentication processing system according to a related technique. It is assumed herein that a TV receiving apparatus has a communication capability for connecting to the Internet.

When an operator presses a login button disposed on a remote control, a login request is sent to the TV receiving apparatus (S21). When the TV receiving apparatus receives the login request from the remote control, the TV receiving apparatus transmits a login screen transmission request to an authentication server (S22). When the authentication server receives the login screen transmission request from the TV receiving apparatus, the authentication server transmits a login screen to the TV receiving apparatus (S23).

When the TV receiving apparatus receives the login screen from the authentication server, the TV receiving apparatus displays the login screen on a display screen. While viewing the login screen displayed on the display screen, the operator operates the remote control to enter a user name (S24) and a password (S25).

When the TV receiving apparatus receives the user name and the password from the remote control, the TV receiving apparatus transmits the user name and the password to the authentication server and requests the authentication server to start authentication (S26). When the authentication server receives the request to start authentication, the authentication server performs an authentication process using the received user name and password (S27). When the authentication is successfully passed, the authentication server transmits a cloud key (key information) to the TV receiving apparatus. Thus, the TV receiving apparatus acquires the cloud key (S28).

The TV receiving apparatus transmits the acquired cloud key together with a content request to a content providing site (S29). Thus, it becomes possible to view a content provided by the logged-in content providing site on the TV receiving apparatus (S30). In this related technique, the operator is supposed to input his/her user name and password by pressing a button on the remote control to move a cursor key on a character table displayed on the display screen, which is a time-consuming operation. Configurations of information terminal and external apparatus.

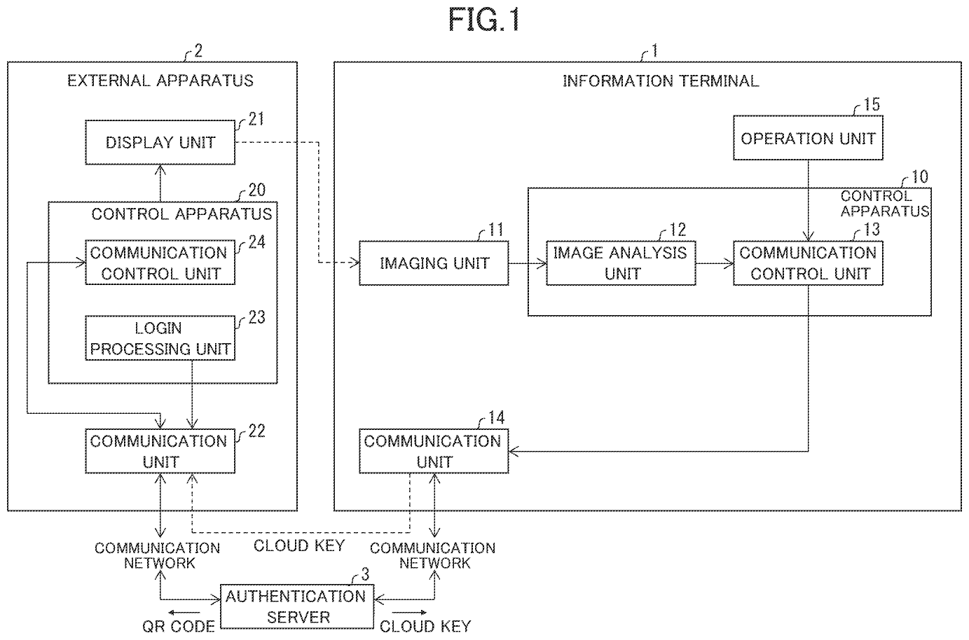

FIG. 1 is a block diagram illustrating functional configurations of an information terminal 1 and an external apparatus 2 according to an embodiment of the present disclosure. The information terminal 1 includes at least one control apparatus 10, at least one imaging unit 11, at least one communication unit (a first communication unit) 14, and at least one operation unit 15. The control apparatus 10 includes an image analysis unit 12 and a communication control unit (a first communication control unit) 13. Note that the number of each of display apparatuses, storage apparatuses, and control apparatuses may be one or plural.

The imaging unit 11 captures an image of a two-dimensional code, for example, a QR (Quick Response) code (registered trademark) displayed on the external apparatus 2, and outputs resultant image information thereof to the image analysis unit 12. As described below, this QR code (registered trademark) includes an embedded identification code (device token) of the external apparatus 2, but does not include information used in authentication. In the following description, it is assumed by way of example but not limitation that the identification code is embedded in the two-dimensional code such as the QR code (registered trademark). However, the identification code itself may be displayed on the external apparatus 2, or the identification code may be transmitted from the external apparatus 2 to the information terminal 1 by wireless communication.

The control apparatus 10 controls the whole information terminal 1 by controlling the imaging unit 11, the communication unit 14, and the operation unit 15. The image analysis unit 12 acquires the QR code (registered trademark) by analyzing the image information captured by the imaging unit 11. The image analysis unit 12 then extracts the identification code of the external apparatus 2 embedded in the QR code (registered trademark).

The communication control unit 13 performs, by controlling communication unit 14, a transmission of a user name and a password used in an authentication process to an authentication server 3, a reception of a cloud key from the authentication server 3, a transmission of the cloud key to the external apparatus 2, and/or the like.

The communication unit 14 is connected to an external communication network via wireless communication, which enables communication with the authentication server 3 described below.

The operation unit 15 includes a touch panel and/or the like as described below, and is used by an operator to input a user name and a password used in authentication, and other information for controlling the information terminal 1 while referring to information displayed on the display screen.

The external apparatus 2 is an apparatus having a display screen such as a TV (television) receiving apparatus having the capability of connecting to the Internet. The external apparatus 2 includes a control apparatus 20, a display unit 21, and a communication unit (a second communication unit) 22. The control apparatus 20 includes a login processing unit 23 and a communication control unit (a second communication control unit) 24.

The display unit 21 is realized using, for example, a liquid crystal display or the like to display a content acquired from a content providing site or the like. The display unit 21 also displays a QR code (registered trademark) acquired from an authentication site. The content acquired from the content providing site may be a moving image or a still image.

The communication unit 22 is connected to an external communication network via a wire or a wireless communication channel to enable communication with the authentication server 3, a content providing site, and/or the like.

The control apparatus 20 performs overall control on the external apparatus 2 by controlling the display unit 21 and the communication unit 22. The login processing unit 23 performs a login process using a cloud key acquired from the information terminal 1. In addition, the communication control unit 24 performs, by controlling the communication unit 22, receiving a QR code (registered trademark) from the authentication server 3, a cloud key from the information terminal 1, and a content from a content providing site.

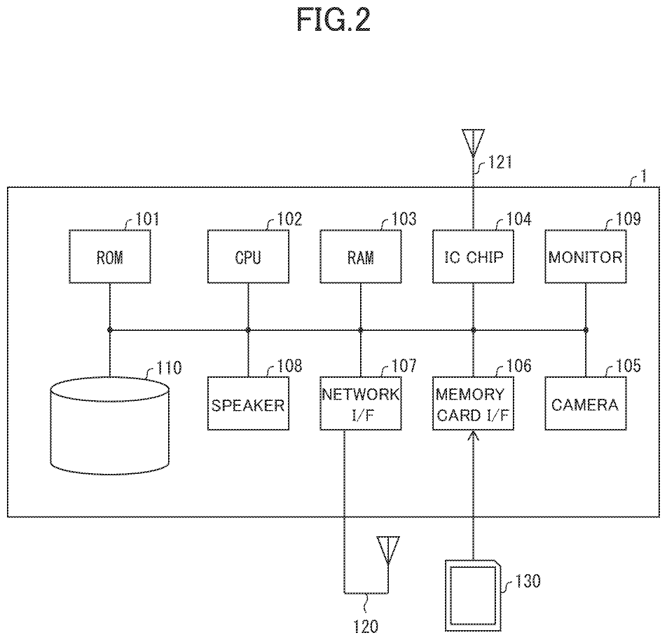

FIG. 2 is a diagram illustrating an example of a hardware configuration of the information terminal 1. The information terminal 1 includes a ROM (Read Only Memory) 101, a CPU (Central Processing Unit) 102, a RAM (Random Access Memory) 103, an IC (Integrated Circuit) chip 104, a camera 105, a memory card I/F (Interface) 106, a network I/F 107, a speaker 108, a monitor 109, an auxiliary storage apparatus 110, and antennas 120 and 121.

The ROM 101 stores an operating system (OS), a control program for controlling the information terminal 1, a boot program to be executed when the information terminal 1 is started, and the like.

The RAM 103 is used as a work area to temporarily store various kinds of data used in executing a control program for controlling the information terminal 1, an application program, and/or the like.

The IC chip 104 is electrically connected to the antenna 121 and communicates wirelessly with other communication device via the antenna 121. For example, the IC chip 104 uses, by way of example but not limitation, near field communication (NFC) in the wireless communication.

The camera 105 corresponds to the imaging unit 11 and is used for capturing an image of a QR code (registered trademark) or the like. The memory card I/F 106 reads and writes data from and to a memory card 130 such as an SD (Secure Digital) card, a CF (Compact Flash (registered trademark)) card, or the like.

The network I/F 107 is electrically connected to the antenna 120 thereby allowing it to connect to a communication network via wireless communication via the antenna 120. The network I/F 107 enables communication with other communication devices connected to the communication network, the external apparatus 2, the authentication server 3, a smartphone, a personal computer, and/or the like.

The speaker 108 outputs a voice/sound transmitted and received to and from another information terminal, music or an electronic sound or the like stored in the information terminal 1. The speaker 108 also outputs a sound to indicate a start or an end of communication with another communication device.

The monitor 109 functions, in cooperation with a touch sensor (not shown), as a touch panel. The operator is allowed to input information while viewing information displayed on the monitor 109 thereby achieving a function of the operation unit 15. The auxiliary storage apparatus 110 stores a control program for controlling the information terminal 1, various application programs, and/or the like.

When the CPU 102 executes the boot program stored in the ROM 101, the information terminal 1 is started. Executing the control program for controlling the information terminal 1 and executing the application program are controlled by executing the OS stored in the ROM 101. Alternatively, the CPU 102 may transfer the control program or the like stored in the auxiliary storage apparatus 110 to the RAM 103 and may execute the control program or the like on the RAM 103.

To realize a function of the image analysis unit 12, the CPU 102 executes a control program and analyzes the QR code (registered trademark) imaged by the camera 105. Furthermore, to realize a function of the communication control unit 13, the CPU 102 executes a control program so as to control the communication unit 14 and the operation unit 15.

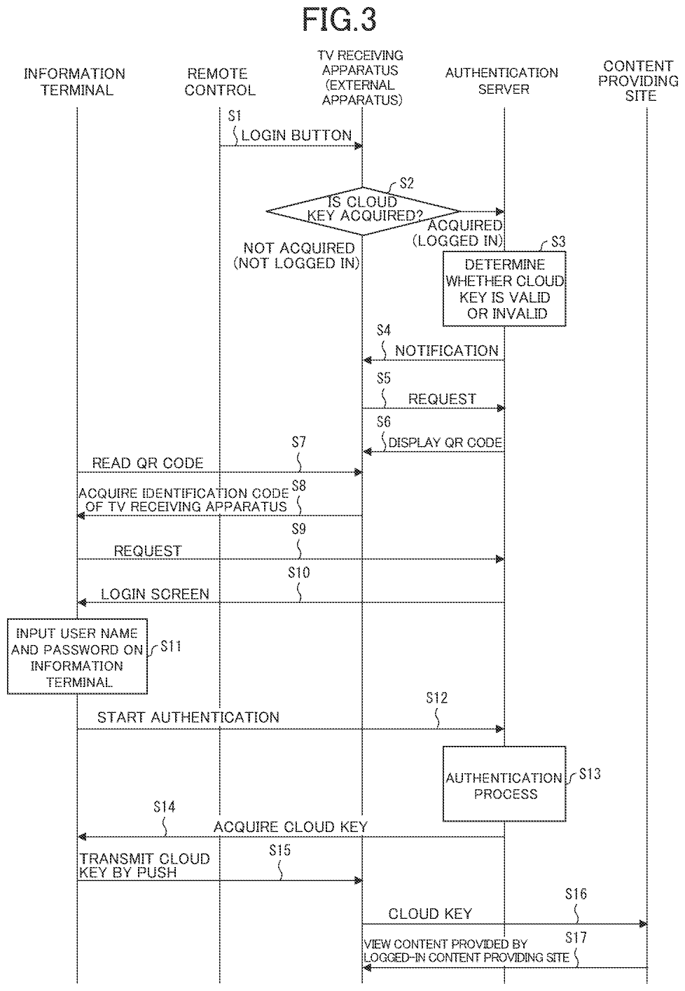

FIG. 3 is a sequence diagram illustrating a processing procedure performed by an authentication processing system including the information terminal 1 and the external apparatus 2. In the following description, it is assumed, by way of example but not limitation, that the external apparatus 2 is a TV (television) receiving apparatus having a communication capability of connecting to the Internet.

First, when an operator presses a login button on a remote control, information indicating this operation is transmitted to the external apparatus 2 via infrared communication or the like (S1). When the external apparatus 2 receives the information indicating that the login button has been pressed, the external apparatus 2 determines whether or not the external apparatus 2 has already acquired a cloud key for viewing a content provided from a content providing site (S2). In a case where the cloud key has not been acquired (logged out, or not logged in) (not acquired in S2), the processing flow proceeds to S5.

In a case where the cloud key has already been acquired (logged in) (acquired in S2), the external apparatus 2 transmits the cloud key to the authentication server 3. The authentication server 3 determines whether or not the cloud key received from the external apparatus 2 is invalid (expired or set by an administrator to a logout state for some reason) (S3). The authentication server 3 notifies the external apparatus 2 whether the cloud key is valid or invalid (S4).

In a case where the cloud key is valid, the external apparatus 2 transmits a content viewing request together with the cloud key to the content providing site. In this case, the process proceeds to S16 without performing the processes in S5 to S15.

In a case where the external apparatus 2 has not acquired the cloud key (not acquired in S2), or in a case where the authentication server 3 determines that the cloud key is invalid, the external apparatus 2 transmits, to the authentication server 3 via the communication unit 22, a request for displaying of the QR code (registered trademark) (S5).

The authentication server 3 manages identification information (device token) for identifying the external apparatus 2 and a correspondence table indicating a correspondence with an actual device. When the request for displaying the QR code (registered trademark) is received from the external apparatus 2, the authentication server 3 acquires identification information of the external apparatus 2 by referring to the correspondence table. The authentication server then generates the QR code (registered trademark) in which the identification information of the external apparatus 2 is embedded, and transmits it to the external apparatus 2 (S6). Note that this QR code (registered trademark) does not include information related to the authentication.

When the external apparatus 2 receives the QR code (registered trademark) from the authentication server 3, the external apparatus 2 displays the QR code (registered trademark) on the display unit 21. When the imaging unit 11 captures an image of the QR code (registered trademark) displayed on the display unit 21 in accordance with a command issued by the operator via the information terminal 1 (S7), the image analysis unit 12 of the information terminal 1 acquires the identification information of the external apparatus 2 by analyzing the QR code (registered trademark) (S8). The communication control unit 13 of the information terminal 1 stores the identification information of the external apparatus 2 in the RAM 103 or the like, such that the identification information is saved as a destination to which the cloud key is to be transmitted after the authentication is successfully completed.

Next, the communication control unit 13 of the information terminal 1 transmits, to the authentication server 3 via the communication unit 14, a login screen transmission request (S9). When the authentication server 3 receives the login screen transmission request from the information terminal 1, the authentication server 3 transmits the login screen to the information terminal 1 (S10). Note that the information terminal 1 stores, in advance, information indicating a destination address of the authentication server 3 and/or the like, and the information terminal 1 accesses the authentication server 3 based on the information.

When the information terminal 1 receives the login screen from the authentication server 3, the information terminal 1 displays the login screen on the monitor 109. An operator inputs a user name and a password via the operation unit 15 while viewing the login screen displayed on the monitor 109 of the information terminal 1 (S11).

When the user name and the password are input, the communication control unit 13 of the information terminal 1 transmits the user name and the password to the authentication server 3 via the communication unit 14. In response, the authentication server 3 starts authentication (S12).

The authentication server 3 performs an authentication process using the user name and the password received from the information terminal 1 (S13). When the authentication is successfully passed, the authentication server 3 transmits a cloud key to the information terminal 1. The communication control unit 13 of the information terminal 1 receives the cloud key from the authentication server 3 via the communication unit 14. Thus, the cloud key is acquired (S14).

The communication control unit; 13 of the information terminal 1 transmits the cloud key to the external apparatus 2 by a push notification (S15). Note that in this push notification, the transmission is not performed such that the cloud key is transmitted directly from the information terminal 1 to the external apparatus 2 is not performed in a directly manner. For example, when the information terminal 1 requests a transmission of a message (the cloud key) to a destination specified by the identification information (the device token) of the external apparatus 2, an application server requests a transmission server for transmission of the specified identification information. The transmission server transmits a message (the cloud key) to the external apparatus 2 specified as the destination of the identification information.

When the communication control unit 24 of the external apparatus 2. receives the cloud key using the push notification from the information terminal 1 via the communication unit 22, the login processing unit 23 transmits a content viewing request together with the cloud key via the communication unit 22 to a content providing site (S16). The content providing site transmits the content requested by the external apparatus 2 to the external apparatus 2 (S17). Thereafter, the external apparatus 2 uses the same cloud key in viewing requests for different contents until login is performed again.

As described above, according to the present embodiment, the information terminal 1 acquires the identification information of the external apparatus 2 by reading the QR code (registered trademark) displayed on the external apparatus 2, and transmits the cloud key, obtained via the authentication process performed between the authentication server 3 and the information terminal 1, to the destination (external apparatus 2) indicated by the identification information (external apparatus 2), and thus, the authentication process can be performed without using the remote control for use to operate the external apparatus 2. That is, it becomes possible to perform the authentication process only by operating the information terminal 1, which a user is accustomed to operating, without performing a button operation on the remote control. Thus, an improvement in operability is achieved.

In addition, since the acquisition of the cloud key by the information terminal 1 and the viewing of the content by the external apparatus 2 using the cloud key are performed by SSL (Secure Sockets Layer) communication, it is difficult for a third person to intercept.

Furthermore, after the external apparatus 2 acquires the cloud key from the information terminal 1, it is allowed to view contents provided from the content providing site without performing a further authentication process. Thus, a reduction in the processing load on the authentication server 3 is achieved.

### SUMMARY OF EMBODIMENTS

According to Aspect 1, the present disclosure provides an information terminal including at least one control apparatus, at least one imaging unit, at least one communication unit, and at least one operation unit, the control apparatus being configured to perform a process of acquiring identification information of an external apparatus by analyzing an image including the identification information of the external apparatus wherein the image is obtained by the imaging unit by imaging the identification information displayed on the external apparatus, a process of, via the communication unit, transmitting information, which is to be used in an authentication process and which is input via the operation unit, to an authentication server and receiving key information from the authentication server, and a process of transmitting the key information by using the identification information to the external apparatus via the communication unit.

Thus, it becomes possible to perform the authentication process without using a remote control that is for operating the external apparatus. That is, it becomes possible to perform the authentication process only by operating the information terminal, which a user is accustomed to operating, without performing a button operation on the remote control. Thus, an improvement in operability is achieved.

According to Aspect 2 of the present disclosure, the control apparatus may perform the process of transmitting the key information to the external apparatus by using a push notification.

The push notification is performed via SSL communication, and thus it is difficult for a third person to intercept.

According to Aspect 3, the present disclosure provides a control apparatus configured to control an information terminal, the information terminal including at least one imaging unit, at least one communication unit, and at least one operation unit, the control apparatus including an image analysis unit configured to acquire identification information of an external apparatus by analyzing an image including the identification information of the external apparatus wherein the image is obtained by imaging, by the imaging unit, the identification information displayed on the external apparatus, and a communication control unit configured to perform, via the communication unit, transmitting information, which is to be used in an authentication process and which is input via the operation unit, to an authentication server, receiving key information from the authentication server, and transmitting the key information by using the identification information to the external apparatus.

Thus it becomes possible to perform the authentication process without using the remote control for use to operate the external apparatus. That is, it becomes possible to perform the authentication process only by operating the information terminal, which a user is accustomed to operating, without performing a button operation on the remote control. Thus, an improvement in operability is achieved.

According to Aspect 4, the present disclosure provide an external apparatus including at least one control apparatus, at least one communication unit, and at least one display unit, the control apparatus being configured to perform a process of performing control such that an image including identification information of the external apparatus is displayed on the display unit, a process of receiving, via the communication unit, key information transmitted from an information terminal by using the identification information, and a process of transmitting, via the communication unit, a content viewing request using the key information.

This aspect enables it to perform the authentication process without using the remote control for use to operate the external apparatus. That is, it becomes possible to perform the authentication process only by operating the information terminal, which a user is accustomed to operating, without performing a button operation on the remote control. Thus, an improvement in operability is achieved.

According to Aspect 5, the present disclosure provides an authentication processing system including an information terminal and an external apparatus, wherein the external apparatus displays an image including identification information of the external apparatus, the information terminal performs imaging the image displayed on the external apparatus, acquiring identification information of the external apparatus by analyzing the image obtained by the imaging, transmitting information, which is to be used in an authentication process and which is input by a user, to an authentication server, and transmitting, using the identification information, key information received from the authentication server to the external apparatus, and the external apparatus transmits a content viewing request using the key information received from the information terminal.

This aspect enables it to perform the authentication process without using the remote control for use to operate the external apparatus. That is, it becomes possible to perform the authentication process only by operating the information terminal, which a user is accustomed to operating, without performing a button operation on the remote control. Thus, an improvement in operability is achieved.

According to Aspect 6, the present disclosure provides an authentication method in an authentication processing system, authentication processing system including an information terminal and an external apparatus, the authentication method including by the external apparatus, displaying an image including identification information of the external apparatus, by the information terminal, capturing the image displayed on the external apparatus, analyzing the captured image, and acquiring the identification information of the external apparatus, by the information terminal, transmitting information, which is to be used in an authentication process and which is input by a user, to an authentication server and receiving key information from the authentication server, by the information terminal, transmitting the key information using the identification information to the external apparatus, and by the external apparatus, transmitting a content viewing request, using the key information received from the information terminal, to a content providing site.

This aspect enables it to perform the authentication process without using the remote control for use to operate the external apparatus. That is, it becomes possible to perform the authentication process only by operating the information terminal, which a user is accustomed to operating, without performing a button operation on the remote control. Thus, an improvement in operability is achieved.

Note that the present disclosure is not limited to embodiments described above, and various modifications are possible within the scope described in claims. Embodiments obtained by combining the technical means disclosed in the embodiments also fall within the technical scope of the present disclosure. A new technical feature may be achieved by combining technical means disclosed in the embodiments.

The present disclosure contains subject matter related to that disclosed in Japanese Priority Patent Application JP 2020-068184 filed in the Japan Patent Office on Apr. 5, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information terminal comprising at least one control apparatus, at least one imaging unit, at least one communication unit, and at least one operation unit,
the control apparatus being configured to perform
a process of acquiring identification information of an external apparatus by analyzing an image including the identification information of the external apparatus wherein the image is obtained by the imaging unit by imaging the identification information displayed on the external apparatus,
a process of, via the communication unit, transmitting information, which is to be used in an authentication process and which is input via the operation unit, to an authentication server and receiving key information from the authentication server, and
a process of transmitting the key information by using the identification information to the external apparatus via the communication unit.

2. The information terminal according to Claim 1, wherein the control apparatus performs the process of transmitting the key information to the external apparatus by using a push notification.

3. A control apparatus configured to control an information terminal, the information terminal comprising
at least one imaging unit, at least one communication unit, and at least one operation unit, the control apparatus comprising:
an image analysis unit configured to acquire identification information of an external apparatus by analyzing an image including the identification information of the external apparatus wherein the image is obtained by imaging, by the imaging unit, the identification information displayed on the external apparatus: and
a communication control unit configured to perform, via the communication unit, transmitting information, which is to be used in an authentication process and which is input via the operation unit, to an authentication server, receiving key information from the authentication server, and transmitting the key information by using the identification information to the external apparatus.

4. An external apparatus comprising at least one control apparatus, at least one communication unit, and at least one display unit,
the control apparatus being configured to perform:
a process of performing control such that an image including identification information of the external apparatus is displayed on the display unit;
a process of receiving, via the communication unit, key information transmitted from an information terminal by using the identification information; and
a process of transmitting, via the communication unit, a content viewing request using the key information.

5. An authentication processing system comprising an information terminal, and an external apparatus,
the external apparatus being configured to display an image including identification information of the external apparatus,
the information terminal being configured to perform:
imaging the image displayed on the external apparatus;
acquiring identification information of the external apparatus by analyzing the image obtained by the imaging;
transmitting information, which is to be used in an authentication process and which is input by a user, to an authentication server; and
transmitting, using the identification information, key information received from the authentication server to the external apparatus, and
the external apparatus being configured to transmit a content viewing request using the key information received from the information terminal. 6. An authentication method in an authentication processing system, the authentication processing system comprising an information terminal and an external apparatus, the authentication method comprising:
by the external apparatus, displaying an image including identification information of the external apparatus;
by the information terminal, capturing the image displayed on the external apparatus, analyzing the captured image, and acquiring the identification information of the external apparatus;
by the information terminal, transmitting information, which is to be used in an authentication process and which is input by a user, to an authentication server and receiving key information from the authentication server;
by the information terminal, transmitting the key information using the identification information to the external apparatus; and
by the external apparatus, transmitting a content viewing request, using the key information received from the information terminal, to a content providing site.
